(19) United States
(12) Patent Application Publication
(10) Pub. No.: US 2003/0154314 A1
(43) Pub. Date: Aug. 14, 2003

(54) Redirecting local disk traffic to network attached storage

(75) Inventors: Robert S. Mason JR., Uxbridge, MA (US); Brian L. Garrett, Hopkinton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: I/O Integrity, Inc., Medway, MA

(21) Appl. No.: 10/361,483

(22) Filed: Feb. 7, 2003

Related U.S. Application Data
(60) Provisional application No. 60/355,540, filed on Feb. 8, 2002.

(51) Int. Cl. G06F 15/16

(52) U.S. Cl. 709/250

(57) ABSTRACT

An apparatus and method implemented in embedded software that transparently redirects local hard drive requests to a Network Attached Storage (NAS) subsystem is provided. The apparatus, contains a large front end cache used to intercept local hard disk I/O requests at the lowest level before forwarding to an external network attached NAS subsystem, providing a transparent high performance centrally managed storage solution.

### RELATED APPLICATION

This application claims the benefit of U.S. Provisional Application No. 60/355,540, filed on Feb. 8, 2002. The entire teachings of the above application are incorporated herein by reference.

### BACKGROUND OF THE INVENTION

This invention relates generally to the field of storage controllers and network attached storage, and more particularly to intercepting local hard drive requests from a PC or server and transparently redirecting them to a Network Attached Storage subsystem.

It is estimated that over 80% of data is stored on local hard drives attached to Personal Computers (PCs). Much of this data is vital corporate data residing on desktops in corporations and small businesses. It is also estimated that up to 96% of all business PCs are not backed up on a regular basis or at all. Each time a user loses a file that was not backed up, or all the data in a hard drive that has failed, many hours of manpower are expended trying to recover or recreate that data.

As drive densities have increased, backup methods for PC and server users have failed to provide the capacity, speed, and ease of use that is required. A common method used for home PCs and small businesses is to add a backup device and software to each PC. For example, Zip drives which once were the most common device for a few years have recently been replaced by read/write Compact Disk Read Only Memory (CDROM) technology. Each of these technologies are not widely used however because of the incremental cost for each PC, insufficient capacity for a full system backup of the average PC, unacceptably long backup and restore times, and finally because backup is a bothersome inconvenience.

A minority of small businesses and corporations, recognizing the need to protect data assets on local PC hard drives, are using backup servers running network attached backup software. The backup server, typically located in a networking closet or a data center, is attached to the same network of the local PC's needing backup services. The backup server is also connected to a tape subsystem or tape library. A thin backup software client program is run on each PC which communicates with the backup server. Using a user defined schedule and policies, data on local hard drives is then backed up by the thin client reading it from the hard drive on the local PC and sending it to the backup server which spools it to tape. Network attached backup strategies as described above are commonly used to backup servers housing mission critical applications such as mail servers and accounting packages, but are rarely used to backup local PC hard drives due to cost concerns (backup software/hardware and manpower), the amount of network traffic created, and the complexity of full restore procedures.

A Network File System (NFS) is a client/server application a that permits a user to view and optionally store and update files stored on a remote computer as though they were physically located on the user's own computer. The user's system needs to have an NFS client and the other computer needs the NFS server. Both computers typically must have networking protocol software such as Transission Control Protocol/Internet Protocol (TCP/IP) and networking hardware such as Ethernet Network Interface Cards (NICs) installed, since the NFS server and client use network protocols to send the files and updates back and forth.

NFS was developed by Sun Microsystems for Unix-based operating systems and has been designated a file server standard. The NFS protocol uses the Remote Procedure Call (RPC) method of communication between computers. Using NFS, the user or a system administrator can mount all or a portion of a file system (which is a portion of the hierarchical tree in any file directory and subdirectory on a PC). The portion of a file system that is mounted (designated as accessible) can be accessed with whatever privileges are associated with the desired access privilege to each file (such as read-only or read-write).

Common Internet File System (CIFS) is a standard protocol developed by Microsoft that allows programs to make requests for files and services located on remote computers on the Internet. CIFS is typically used by PCs and servers running Microsoft operating systems to gain shared access from one computer to files stored on another remote computer within the same network. The shared drive is accessed as a different drive letter (other than the local “C” drive). Like NFS, CIFS uses the client-server programming model. A client program makes a request of a server program (usually in another computer) for access to a file or to pass a message to a program that runs in the server computer. The server takes the requested action and returns a response. CIFS is a public or open variation of the Server Message Bock (SMB) Protocol. The SMB Protocol is widely used in today's local area networks for server file access and printing. Like the SMB protocol, CIFS runs at a higher level than the Internet's TCP/IP protocol.

The NFS protocol is typically used by Unix clients to gain access to shared files, and the CIFS protocol is similarly used by clients running Microsoft operating systems. A Linux server can be configured to run an NFS server to expose files for sharing on a network; Microsoft's CIFS server yields similar functionality. In one common deployment scenario, a server having a relatively large local disk to be shared is attached to the network via Ethernet and TCP/IP and then NFS or CIFS is employed to serve up the shared data. In more demanding applications, a Network Attached Storage (NAS) subsystem (a.k.a NAS appliance or filer) containing an array of disks, sophisticated disk controller hardware, and embedded software which implements NFS and/or CIFS is used. NAS subsystems often implement data protection schemes to ensure the data integrity of shared files. One popular scheme, Redundant Array of Independent Disk (RAID) technology, including disk device level mirroring (RAID-1), and rotating block striped parity (RAID-5) is used to avoid data loss due to failure of a disk drive. Remote mirroring technology is also used to create an exact duplicate of the entire contents of a NAS subsystem on another NAS subsystem located at a remote site. This protects against a facilities level disaster. Snapshot technology is used to provide the ability to instantly restore a file system to a moment of time in the past, typically to recover a file or group of files that were corrupted or accidentally deleted. The snapshot operation is a user configurable event whereby an image of the data is saved at a pre-defined moment in time (or moments of time in pre-defined intervals). The user can then later go back in time to one of the snapshots and refer to the file system exactly as it appeared in the past. Snapshots are created by using a portion of the disk to log file changes since the last snapshot was taken. Restoration to a snapshot moment in time is performed instantly by referring to the logs avoiding the need to move or restore data. Data protection schemes as described above are often implemented in NAS subsystem embedded code. But, the level of sophistication of the protection schemes varies depending on NAS vendor implementation, NAS model numbers, user budget restraints, and the criticality of the data as perceived by the NAS administrator.

In order to achieve the goal of moving local PC or server hard disk contents to a centrally managed network subsystem, some installations deploy PCs that do not have a local hard disk. A diskless PC must therefore be able to boot without a hard drive. A PC or server cannot typically boot from a network attached NFS or CIFS file system. These file systems are designed to run after a machine has loaded its operating system from a local disk, after a TCP/IP stack is loaded, and finally after an NFS or CIFS client is loaded. Due to this boot problem, network attached storage is not typically used for the storage of local hard drive data, but instead is used to share and protect shared data that appears to the user as another drive letter (Microsoft) or file system (Unix).

A disruptive solution to the diskless boot problem is “thin client” computing. Thin client is a low-cost, centrally managed computer devoid of disk drives, CD-ROM players, diskette drives, and expansion slots. The term derives from the fact that small computers in networks tend to be clients and not servers. Since the idea is to limit the capabilities of these computers to only essential applications, they tend to be purchased and remain “thin” in terms of the client applications they include. The term “thin client” seems to be used as a synonym for both the NetPC and the Network Computer (NC), which are somewhat different concepts. The NetPC is based on Intel microprocessors and Windows software (Intel was a leader in defining the NetPC specification). The Network Computer (NC) is a concept backed by Oracle and Sun Microsystems that may or may not use Intel microprocessors and uses a Java-based operating system. Thin clients boot and load TCP/IP and file sharing client protocol software from a non-volatile component on a printed circuit board, such as a Read Only Memory (ROM).

Thin client computing requires re-architecture of all application software into client and server components. For example, specific applications such as bank teller processing have been architected to run in a thin client environment. More significantly, the standard of the shelf application suites that users are accustomed to running on their desktop PCs such as Microsoft Word are not available for use in a thin client environment. Since thin client computing provides diskless client operation at the cost of user flexibility it has gained acceptance in specialized applications within limited market segments. Moreover, thin client computing is not viewed as a viable solution for the vast millions of PCs designed to run applications from locally attached hard disks.

Network latency affects the performance of NFS/CIFS subsystems. Network transfer rates, e.g. 100 Megabits/second (MB/sec) and network protocol overhead yield access time delays for network attached disk when compared to locally attached disk which serves up data at PC or server bus speeds (e.g. 133 MB/sec burst rate or greater).

Another factor affecting the local storage system design is the practice of maintaining frequently accessed data in high-speed local memory. This feature, which avoids accesses to slower disk media as much as possible is called caching. Caching is now a feature of most disk drives and operating systems, and is often implemented in advanced disk controller hardware. Common caching techniques include Least Recently Used (LRU) replacement, anticipatory pre-fetch, and write through caching. Read requests from a host computer resulting in a disk drive access are saved in cache memory in anticipation of the read data being accessed again in the near future. A cache memory finite in size is quickly filled with such read data. Once full, a method is employed whereby the least recently used data is retired from the cache and is replaced with the latest read data. This method is referred to as Least Recently Used replacement. Read accesses are often sequential in nature and various caching methods are employed to detect such sequentiality in order to pre-fetch the next sequential blocks from storage into the cache so that subsequent sequential access may be service from fast memory. This caching method is referred to as anticipatory pre-fetch. Write data is often referenced shortly after being written to media. Write through caching is therefore employed to save the write data in cache as it is also written safely to storage to improve likely read accesses of that same data. Each of the above cache methods are employed with a goal of reducing network attached storage accesses and increasing memory accesses resulting in significant system performance improvement. Performance benefits can be realized with caching due to the predictable nature of disk workloads. Most Input/Output (I/O) requests to a disk are data reads instead of data writes (typically about 80%) and those reads tend to have a high locality of reference. High locality of reference means that reads that happen close to each other in time tend to come from regions of disk that are close to each other in proximity. Another predictable pattern is that reads to sequential blocks of a disk tend to be followed by more sequential read accesses. This behavior can be recognized and optimized through pre-fetch as described earlier. Finally, data written is most likely read in a short period after the time it was written. The afore mentioned I/O workload profile tendencies make for a cache friendly environment where caching methods can easily increase the likelihood that data will be accessed from high speed cache memory avoiding network attached storage accesses resulting in significant performance improvements.

PC hardware upgrades also pose a problem for users and system administrators. The data on the old PCs needs to be restored on the new PC's hard drive. This painful process is often also required when an operating system upgrade is performed. The data may be backed up and restored using locally attached backup hardware (e.g. tape, Zip drive, Read/Write CDROM), or in a networked environment the contents of the hard drive can be copied to network attached storage (sometimes referred to as ghosting) and then restored from the network attached storage to the PC. The network attached storage method is generally easier to perform and is the preferred method in most large corporations.

A local PC hard drive failure is a similarly traumatic experience. If the user is fortunate to have a locally attached backup device, and has been religious about maintaining backups, then the restore process begins once the old drive has been jettisoned and the new drive has been installed. But a full restore can take quite some time and often involves the steps of re-installing the operating system, then the backup software, then restoring files from the last full backup, and finally application of any incremental backups taken since the last full backup. If the user is in a network setting where local disks are being backed up to a network attached backup server, then the restore process is somewhat similar except that the full and incremental restore traffic needs to flow over the network which may yield very long restore times and increased network traffic effecting performance for all users attached to that same network segment.

### SUMMARY OF THE INVENTION

Several different industry trends therefore create the need and opportunity for the subject invention. More data is stored on locally attached PC hard drives than that in all enterprise level external storage subsystems and servers, and almost none of it is regularly backed up. The recent rapid decline in memory pricing allows a large cache to be implemented to increase performance and decrease delays associated with network access of shared data. Network Attached Storage appliances are gaining in popularity and can now be found in most large corporations. The combination of the subject invention with a network attached storage appliance brings enterprise level data management and protection to the largest areas of storage that exists today: PC hard drives.

More particularly now, the present invention is an adjunct to a data processing system that consists of an Input/Output (I/O) interface for connecting a host system bus to an I/O device bus so that data may be transferred to and from a host central Processing Unit (CPU). A network interface provides access to data that may be written or read by a host CPU via a network attached storage unit. A storage manager, which is located within the same housing as the host processor, is connected to receive data from both the processor and the network interface. The storage manager provides a programming environment that is independent of the host operating system and which allows for implementation of embedded code that intercepts requests for access to a local disk drive that occur on the I/O interface, redirecting such requests to the network interface in a manner that is independent of the host system bus configuration.

In a preferred embodiment, the storage manager is located in band on the I/O device bus between the I/O interface and the disk storage unit. The storage manager typically intercepts drive requests based on logical block addresses, translating them to byte offsets within a file that resides on the network attached storage.

A particular advantageous naming convention for files located on the network storage device includes specifying the Media Access Control (MAC) layer address of the apparatus along with an index number for the specific files relating to that specific apparatus. Since the MAC address is a unique address assigned to each network hardware apparatus, it is guaranteed that the file name will remain unique for a number of devices that may be using a given network attached storage device.

A number of different storage interfaces may be used with the invention, including standard devices such as Integrated Device Electronics (IDE), enhanced IDE, Small Computer System Interface, Advanced Technology Attachment, Fiber Channel and other similar disk storage interfaces.

The storage manager preferably uses a software architecture that is implemented over a multithreaded real time operating system that permits isolating front end bus interface, network interface and management functions as separate tasks.

The storage manager may be provided in a number of different physical formats such as in the Peripheral Component Interconnectal (PCI) interface board format, standard disk drive enclosure format, or an integrated circuit that is easily adaptable to the standard interior configuration of a personal computer.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B illustrate, respectively, a standard computer and an apparatus that redirects disk traffic to network attached storage;

FIG. 2 indicates how the apparatus is logically configured into a system;

FIG. 3 indicates how the apparatus is physically configured into a system;

FIG. 4 is a hardware overview of the apparatus;

FIG. 5 is a software overview of the apparatus;

FIG. 6 is a diagram indicating the data layout of files representing a disk;

FIG. 7 is a migration method flowchart;

FIG. 8 is a read processing method flowchart;

FIG. 9 is a write processing method flowchart; and

FIG. 10 depicts hard drive block address to NFS file offset translation.

### DETAILED DESCRIPTION OF THE INVENTION

A description of preferred embodiments of the invention follows.

The present invention is directed to a storage manager platform which is located within a host computer system connected in a manner which is host processor, system bus and operating system independent providing transparent redirection of local hard drive requests to a centrally managed Network Attached Storage (NAS) subsystem.

In the following description, it is to be understood that the system elements having equivalent or similar functionality are designated with the same reference numerals in the Figures. Preferably the present invention is implemented in application code running over a multi-tasking pre-emptive Real Time Operating System (RTOS) on a hardware platform comprised of one or more embedded Central Processing Units (CPU), a Random Access Memory (RAM), and programmable input/output (I/O) interfaces. It is to be appreciated that the various processes and functions described herein may be either part of the hardware, embedded micro-instructions running on the hardware, or application code executed by the RTOS. But it should be further understood that the present invention may be implemented in various other forms of hardware, software, firmware, or a combination thereof.

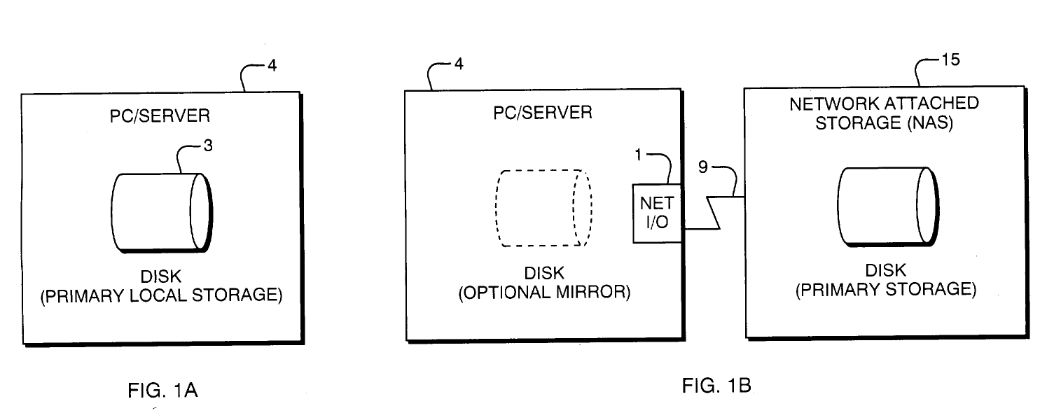

Referring now to FIG. 1A, a high level logical overview diagram illustrates how local hard drive requests made by a PC, server, or other host computer (4) are redirected over a network interface (9) to a NAS subsystem (15) by a Network Input/Output (referred to hereafter as “Net I/O” and/or the “storage management platform”) apparatus (1). A PC, server, or other host computer system (4) before the installation of Net I/O is depicted in FIG. 1A with a local hard drive (3) used for primary local storage, as is well known in the art. After the installation of the Net I/O apparatus (1), as shown in FIG. 1B, I/O requests intended for the local hard drive (which may no longer in fact exist) are transparently redirected over the network interface (9) to storage device(s) within a NAS subsystem (15).

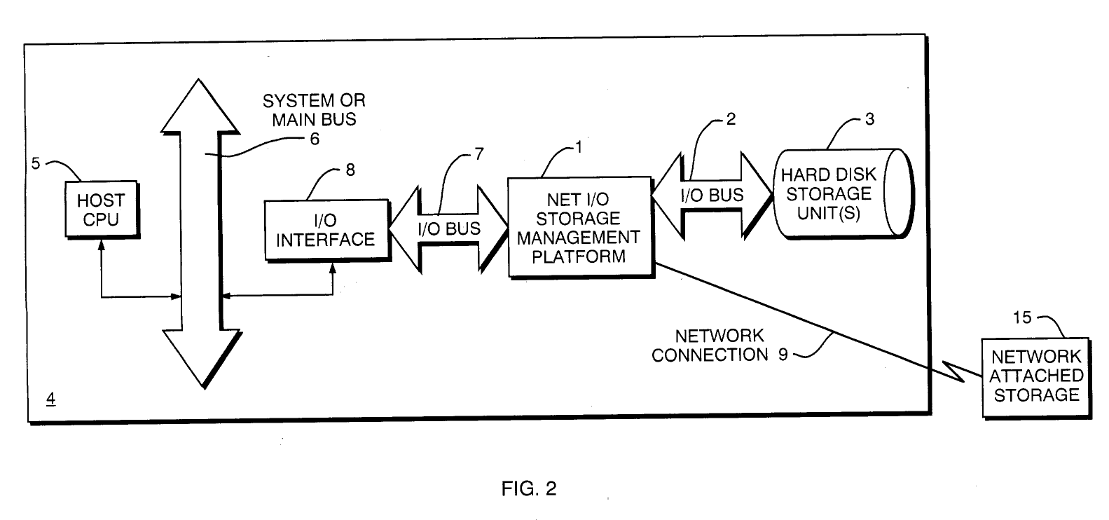

FIG. 2, is a high level block diagram that illustrates how the Net I/O or storage management platform (1) is architecturally configured in a host computer system (4) according to one embodiment of the current invention. The host computer system (4) comprises a host central processing unit (5), a system bus (6), I/O interface circuitry or a host bus adapter, hereafter referred to collectively as an I/O interface (8), an I/O bus (7)/(2) and a storage device (3). One example of a host computer system (4) configured in this manner is a Personal Computer (PC) with a Pentium CPU (5) connected by a PCI system bus (6) to a chip set on a motherboard containing ATA (a.k.a. IDE) disk interface circuitry (8) with a hard disk drive (3) connected via an ATA bus (7) and (2). Note that all of the components of the host computer system described in this diagram, including the storage devices, are contained in the same housing denoted as (4).

The storage management platform (1) is a hardware apparatus running storage application software that is configured in-band on the I/O bus interface between the host CPU (7) and the storage device (2). The storage management platform (1) has an Ethernet network connection (9) to a Network Attached Storage (NAS) subsystem (15). Configured in this manner the storage management platform (1) sits behind the I/O controller interface (8) and in front of the local hard disk (3) appearing to the host CPU (4) as a local hard disk while transparently redirecting I/O requests to the NAS subsystem (15).

The system of FIG. 2 generally operates as follows. When an I/O request for data residing on the disk (3) (which may or may not be physically present) is issued by the host CPU (5) through the I/O interface (8), one or more I/O commands are sent over the I/O bus (7)/(2) towards the hard disk (3). The I/O requests arriving on the I/O bus (7) are block based commands comprised of a Logical Block Address (LBA) and a Logical Block Count (LBC) describing the number of blocks to read or write. As described in greater detail below, the storage management platform (1) intercepts those block based I/O requests directed towards the internal hard disk drive (3) and translates them into external NFS file read and write requests, routing the requests and data over the Ethernet interface (9) for execution by the NAS subsystem (15). The storage management platform executes the I/O requests directly and may emulate those requests avoiding access to the NAS subsystem through the use of intelligent caching techniques. In this manner, this embodiment of the current invention redirects local hard drive I/O requests to centrally managed pool of files residing on an external NAS subsystem. As will be understood shortly, the storage management platform (1), may also provide application performance enhancement and decreased Ethernet traffic through intelligent caching.

According to the embodiment of the invention described above, local hard drive requests arriving on the I/O bus (8) are redirected by the storage management platform to an external NAS subsystem (15) via the Ethernet interface (9). In such an embodiment the local hard drive is removed from the system yielding locally disk-less operation. According to another embodiment of the invention, the local hard disk storage unit (3) is used to hold a mirrored copy of the file based representation on the NAS subsystem (15). In such an embodiment, the Net I/O storage management platform (1) is responsible for synchronization of the contents of the NAS subsystem (15) and the local hard disk (3). If the Ethernet interface (9) or NAS subsystem (15) is unavailable or “down”, then the local hard disk (3) is used to service local hard drive requests arriving on the I/O interface (7). If the network interface and NAS subsystem later return to operation, then the Net I/O storage management platform (1) re-synchronizes the NAS image by issuing writes over the Ethernet interface (9) for those regions of disk that were updated during the outage. In this manner the NAS image is a primary copy of local hard drive data that may be centrally managed and backed up and the local hard drive is a secondary mirrored copy for use in the event that the Net I/O storage management subsystem can not access the NAS subsystem through the Ethernet network.

According to one embodiment of the current invention, the local I/O interface of the storage management platform (8) is Advanced Technology Attachment (AKA), also known as Integrated Device Electronics (IDE). According to another embodiment, the I/O interface (8) is Small Computer System Interface (SCSI). With the appropriate hardware and embedded software support in the Net I/O apparatus (1), embodiments of the current invention can be implemented to support any I/O interface including other emerging standards (e.g. ATA).

According to one embodiment, the external NAS subsystem (15) interface is NFS with file reads and writes being issued from an NFS client running within the Net I/O platform (1) directed towards an NFS server running within the NFS subsystem (15).

According to another embodiment, the external I/O interface is Internet SCSI (iSCSI). The Net I/O platform in such an iSCSI attached embodiment redirects local block based hard drive requests to the iSCSI subsystem supporting SCSI block based requests over Ethernet. In this embodiment, the NAS subsystem (15) is an iSCSI subsystem and the use of the Net I/O platform (1) obviates the need for driver installation on the PC or server (4) such that the host CPU (5) is operating as if it were attached to a local hard drive (3) over an internal I/O interface (8).

Since the storage management platform is configured on the I/O bus and not the system bus, the preferred embodiment of the subject invention is host CPU independent, operating system independent, and does not require the installation of a storage management platform specific driver.

It is to be understood that although FIG. 2 illustrates a hard disk (3), the storage management platform may be employed with any form of I/O bus attached memory device including all forms of sequential, pseudo-random, and random access storage devices. Storage devices known within the current art include all forms of random access memory, magnetic and optical tape, magnetic and optical disk, along with various forms of solid state mass storage devices.

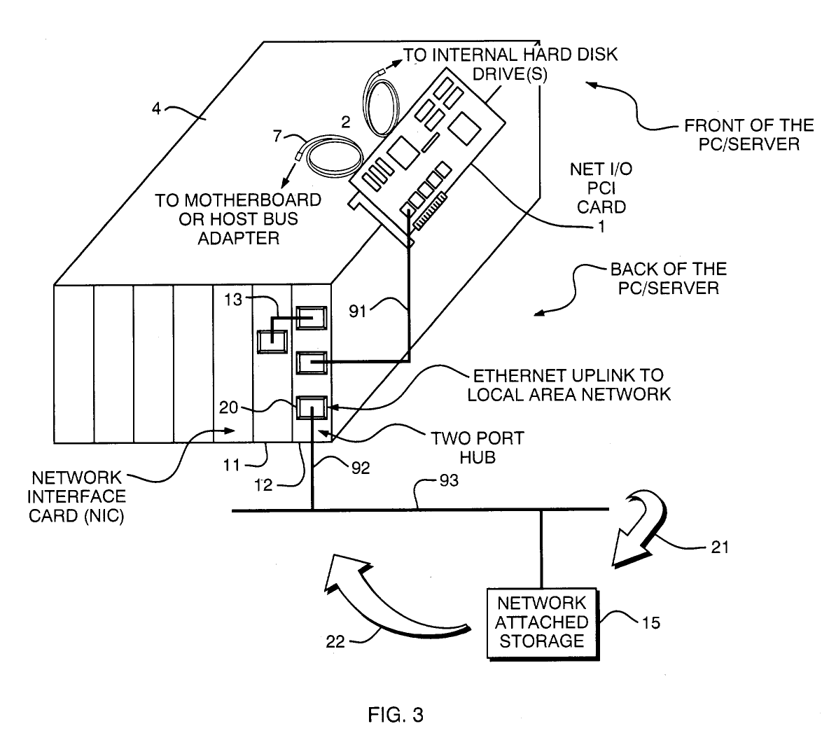

Physical connectivity of the Net I/O apparatus (1) is depicted in FIG. 3. The Net I/O apparatus (1) depicted in a Peripheral Component Interconnect (PCI) card form factor is located within a PCI slot within a PC/server system (4). The Net I/O interface card (1) has two I/O bus interface connectors: one for connection with the host I/O interface on a motherboard or host bus adapter (7) and a second for connection with the internal hard drive (2). Thus the Net I/O (1) sits “in line” on the host I/O bus (7)/(2). An Ethernet connection (91) is used to communicate with the Network Attached Storage subsystem (15). The Ethernet connection (91) from the Net I/O (1) PC card is connected to a two port Ethernet hub which occupies a PCI slot (12). The uplink port on the hub (20) is connected to the same Local Area Network (LAN) (93) to which the NAS subsystem (15) is attached. The Ethernet network interface card (11) of the PC is connected to the hub (12) with a patch cable (13). In this manner, a single external network interface connection (92) from the PC/server (4) is provided for connections to the local area network (93). Configured as described above, the Net I/O PC card manages write data flow to the NAS subsystem (21) and read data flow from the NAS subsystem (22).

It should be noted that although the Net I/O PCI card (1) is plugged into the PCI bus, no data is moved over the PCI bus. Only electrical power is obtained form the PCI bus. Data flows instead through the front-end host I/O interface (7), the back-end drive interface (2), and the Ethernet interface (91).

Another embodiment of the current invention packages the Net I/O apparatus (1) in a hard drive form factor. In this form factor, the Net I/O implementation (1) has an I/O interface connector (e.g., ATA) for connection with the host interface on a motherboard or host bus adapter and a power connector. In addition, such an embodiment has an Ethernet connector and an additional I/O interface connector.

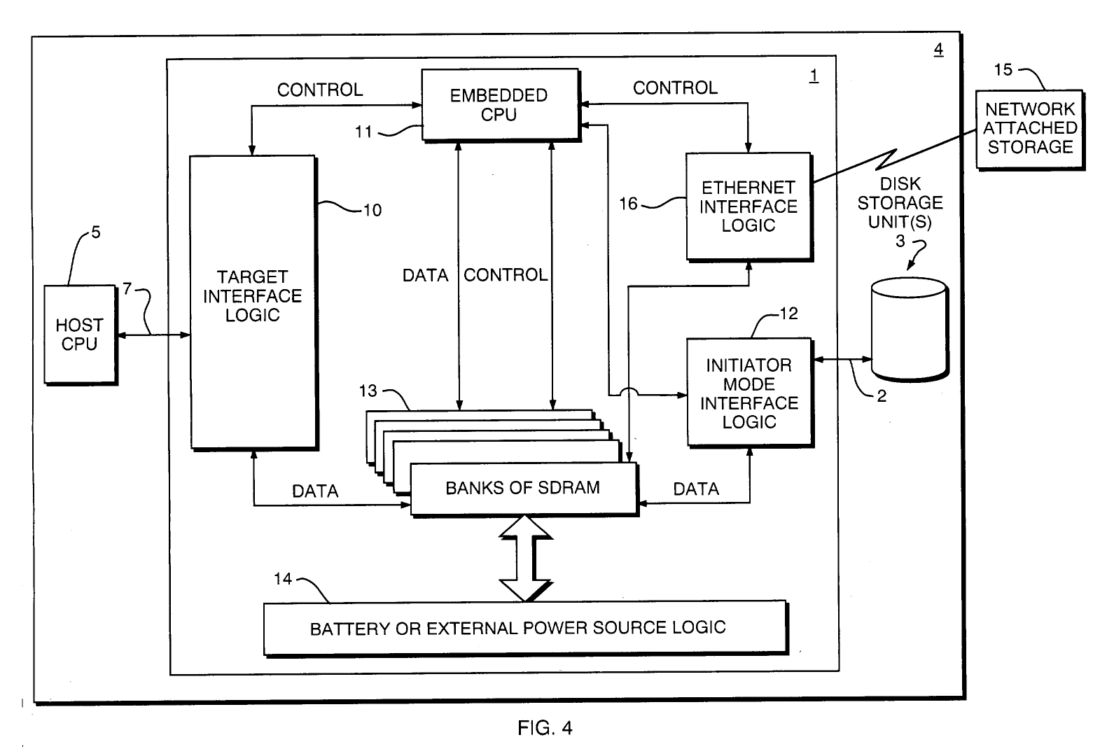

FIG. 4 is a high level block diagram of the hardware components of the Net I/O storage management platform (1) according to another embodiment of the current invention. Here, the storage management platform (1) is housed within a computer system (4) comprised of a host CPU (4) connected to a disk storage unit (3) via an I/O bus (7) and (2). The storage management platform (1) is comprised of an embedded CPU (11), target mode interface logic (10) which manages I/O bus interface protocol communication with the host I/O interface (8), Ethernet interface logic (16) which manages I/O interface protocol communication with the external Network attached storage subsystem (15), initiator mode interface logic (12) which manages I/O interface protocol communication with the storage unit (3), banks of Synchronous Dynamic Random Access Memory (SDRAM) for cache and control data (13), and a battery or external power source logic (14) to enable write caching. The DMA Data paths to the and from the host, disk, and NAS devices are managed by the embedded CPU (11) via Control paths as depicted in the diagram.

The system of FIG. 4 generally operates as follows. A read request arrives at the storage management platform on the host I/O bus (7) and is processed by target Interface logic (10) under the direction of the embedded CPU (11). If the I/O request is a read request for data residing on the disk storage unit (3), then a cache lookup is performed to see if the data resides in the cache memory region in SDRAM (13). If the data is not found in cache (a miss), then the CPU builds and sends the read request to the Ethernet logic (16) for transmission over the external Ethernet interface (9) to the external NAS subsystem (15). Some time later, the CPU is notified that the transfer of data from the NAS subsystem to the cache memory region in SDRAM (13) is complete, and the CPU then directs the target interface logic (10) to transfer the read data from the cache memory region in SDRAM over the host I/O bus (7) finishing the I/O request. A subsequent read to the same blocks of data whereby the read data is found in cache (a hit) results in a transfer of that data over the host I/O bus (7) avoiding disk access and the involvement of the initiator mode interface logic (12) and the NAS subsystem (15). Write requests arriving on the host I/O bus (7) result in a transfer of write data into the cache memory region of SDRAM (13) by the target Interface logic (10) under the direction of the embedded CPU (11). The write request is reported as complete to the host once the data has been transferred over the host I/O bus (7). Later on, a background task running under the control of the embedded CPU (11) de-stages write requests in the cache region of SDRAM (14) out to the NAS subsystem (15) over the Ethernet interface (15) using the Ethernet interface control logic (16). Write data residing in the cache region of SDRAM (13) waiting to de-stage to the disk storage unit is protected by a battery or an external power source composed of an AC/DC converter plugged into an Uninterruptible Power Source (UPS) (14) so that in the event that system power is lost, the SDRAM can be put into a low power mode and the write data may be preserved until power is restored. In another embodiment of the current invention, the Net I/O subsystem (1) includes a battery instead of connection to an external UPS protected power source.

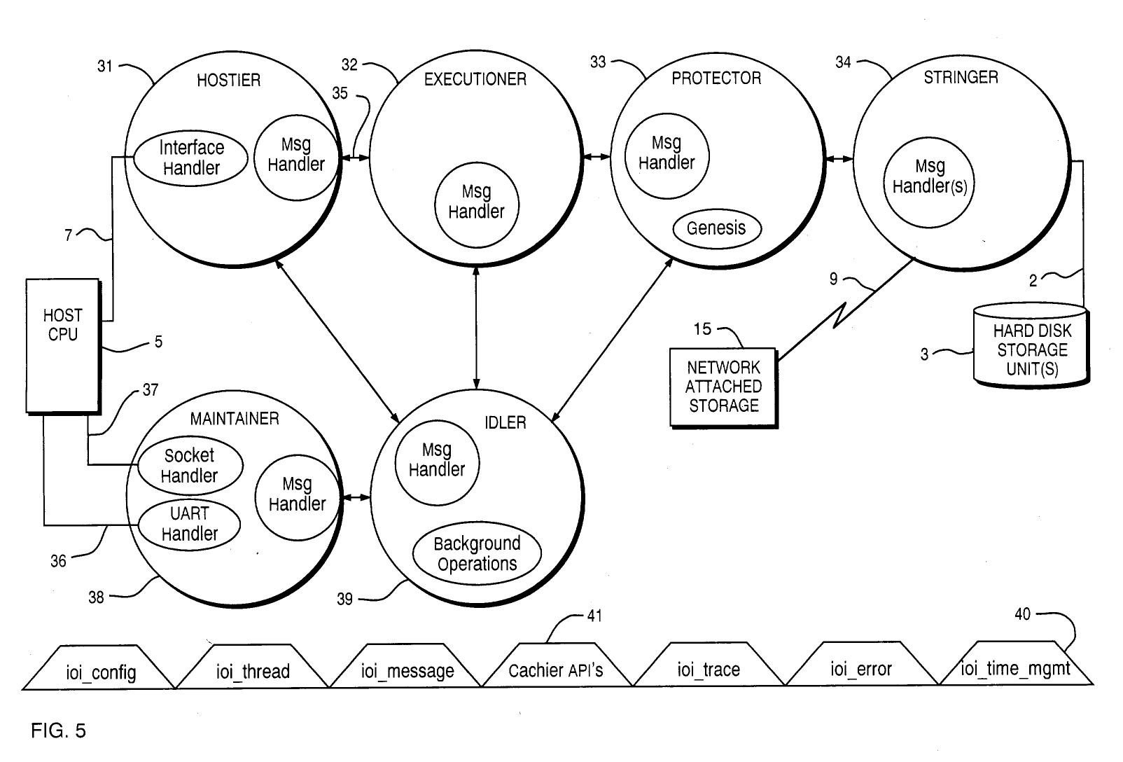

A high level software architecture of the Net I/O storage management platform (1) is depicted in FIG. 5. The software architecture is defined as a set of tasks implemented over a Real Time Operating System (RTOS). The tasks include the Hostier (31), Executioner (32), Protector (33), Stringer (34) Maintainer (38), and Idler (39). Tasks are composed of one or more pre-emptive multi-tasking threads. For example, the Hostier task (31) is composed of an interface handling thread (42) and a message handling thread (43). Tasks communicate via clearly defined message queues (35). Common messages are supported by each task including START_IO and END_IO. Threads within tasks and driver layers abstract hardware interface dependencies from the bulk of the software rendering rapid adaptation to evolving hardware interfaces and standards. The Hostier task (31) is responsible for managing target mode communication with the host I/O interface (7). The Executioner task (32) is a traffic cop with responsibilities including accounting, statistics generation and breaking up large I/O's into manageable chunks. The Protector task (33) is responsible for translating host logical addressable requests to physical device requests, optionally implementing disk redundancy protection through RAID techniques commonly known in the art. The Stringer (34) task is responsible for managing communication with back end devices including hard disk drives (2) and Network Attached Storage (15). The Maintainer task (38) is responsible for managing maintenance traffic over serial and Ethernet interfaces. The Idler task (39) is responsible for background operations including write de-stage management. A set of functions with clearly defined application programming interfaces (40) are provided in the architecture for use by any and all tasks and threads including a set of cache memory management functions designated as the Cachier (41). The software architecture is configured within a computer system comprised of a host CPU (5) connected via a host I/O interface (7) interfaces with the software architecture at the Hostier task (31), to a hard disk storage unit (3) via a device I/O interface (2) and Network attached storage (15) via the Ethernet interface (9) under the direction of the Stringer task (34).

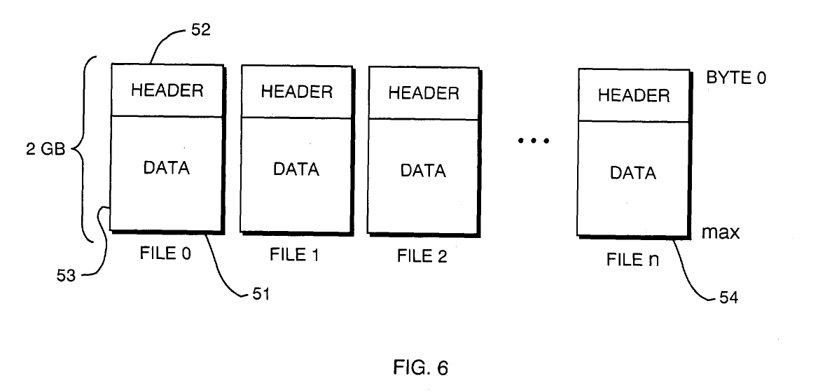

One or more files located on network attached storage device are created and maintained on an NFS device (15) by Net I/O (1) embedded code to represent the contents of a local hard drive. Each file can grow to a fixed size (currently defined at 2 GB) and then a new file is created. As a new file is created a header is added containing meta data describing the contents of the file to follow and its relationship to a local disk and the hardware apparatus. FIG. 6 depicts how multiple files, each with its own header, are used to represent the contents of a disk drive.

The local hard drive has a fixed maximum capacity size represented in a number of blocks (usually 512 bytes per block). The maximum capacity and block size of the drive is returned in response to a command sent from the apparatus to the drive over the local disk interface. The sum total of the size in bytes of the network attached files that represent a single disk drive is less than or equal to the size of the drive plus the size of the headers on each file.

The preferred naming convention for the files located on the network attached storage device is as follows:

NIO_MAC_NN

Where:

NIO is a fixed ASCII string

MAC is the Ethernet Media Access Control (MAC) layer address of the apparatus that owns the file

NN is the file number starting from zero, with no leading zeros (0,1,2, . . . 10,11, etc.)

The MAC address is a unique address assigned to each network hardware apparatus during manufacturing. It is a number the increments sequentially with each unit manufactured based on a base values assigned by IEEE which uniquely identifies the company. The MAC address is stored in Non-Volatile Random Access Memory (NVRAM) on the apparatus and is read by embedded code during initialization.

The header on each file typically contains the following fields:

Length of the data section of the file (excluding the header)

Signature (a fixed ASCII string for validation)

Filer ID info (file name, filer's IP address, . . . )

Drive ID info (capacity, block size, vendor, part no., serial no., . . . )

NetIO ID info (MAC address)

Parameters (chunk size per file, . . . )

State

Maintenance and configuration commands are sent to the apparatus through the Ethernet interface by means of a telnet or Hyper Text Transfer Protocol (HTTP) interface supported in embedded software on the apparatus or in-band on the I/O interface within vendor unique I/O requests inter-mingled amongst read and write commands occurring on the I/O interface. During installation diagnostic status of the apparatus is checked and the I/O address, or Directory Name Service (DNS) name, of the Network Attached Storage (15) to be utilized is entered. Additional configuration details are entered at this time including whether the apparatus has been installed in a system with existing local hard drive data, whether NAS external writes are mirrored to a local hard drive, etc. Configuration data is saved in non-volatile memory on the apparatus.

Configuration of the apparatus after installation into a PC or server with existing local disk storage that is in use is followed by a migration. Migration is the name for the method implemented in embedded software that implements the copy of data from the local drive to network attached storage. A migration is performed when the apparatus has been powered up after installation into a system with existing user data on a hard drive. Note that a migration is not necessary for a system that is manufactured with the subject invention included. In this case all drive requests from the very first power on are redirected to the filer so that a local drive (if present at all) never processes a single read or write request from the host CPU.

FIG. 4 may be referenced to help in the understanding of the relationship and functionality of the target interface, initiator interface and cache memory components of the apparatus architecture referenced in the read and write processing descriptions to follow.

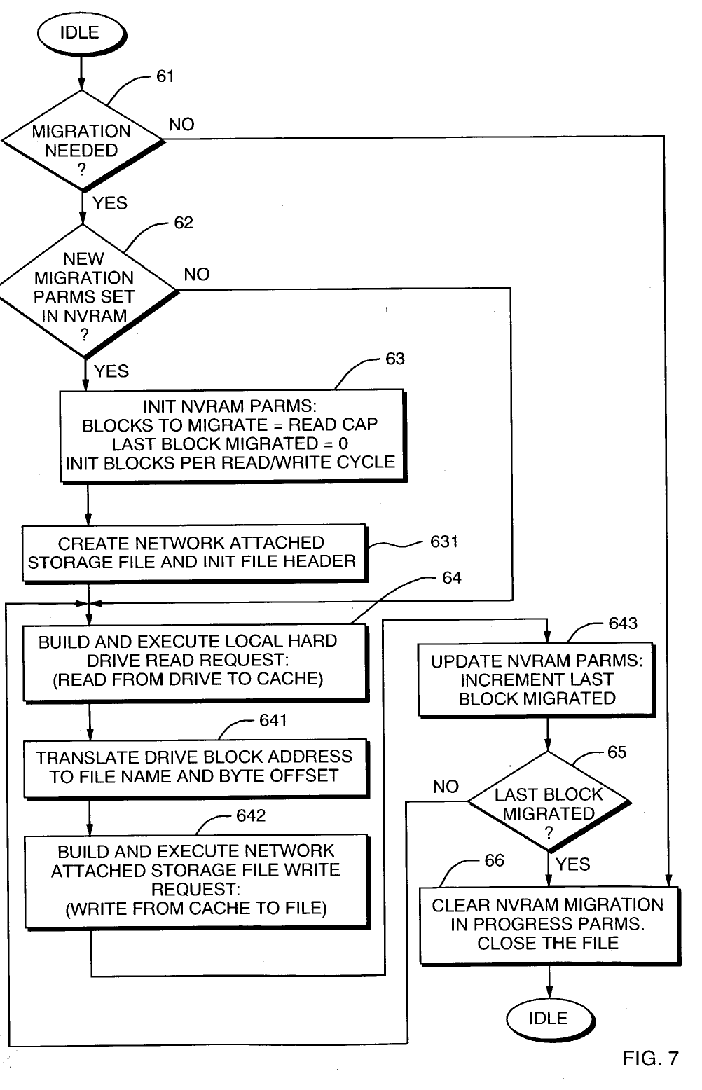

As depicted in flowchart from in FIG. 7, a migration process begins after power up as follows:

Check NVRAM to see if a migration is in progress (61)

If no migration in progress, then the process is done (66) else continue (62)

If new migration requested parameters are set in NVRAM, then

Initialize migration processing parameter in NVRAM (63) as follows:

Obtain the size of drive (drive inquiry request)

Obtain migration chunk size (how much data to migrate with each read request to the drive/write request to the filer) from NVRAM

Init last block migrated to the beginning of the drive (block 0)

Init number of block to migrate (from drive size info)

Initialize File header information as follows

Create file using naming construct described earlier

Write file header in the format as described earlier

Build and execute hard drive read request (64)

Translate drive block address to file name and byte offset (641)

Build and execute network attached storage file write request (642)

Increment last block migrated parameter in NVRAM (643)

If the last block has been migrated (65), then we are done (66) and clear NVRAM migration on progress flags, else return to (62)

During normal operation drive read and requests are redirected to network attached storage file requests transparent to the PC/server CPU.

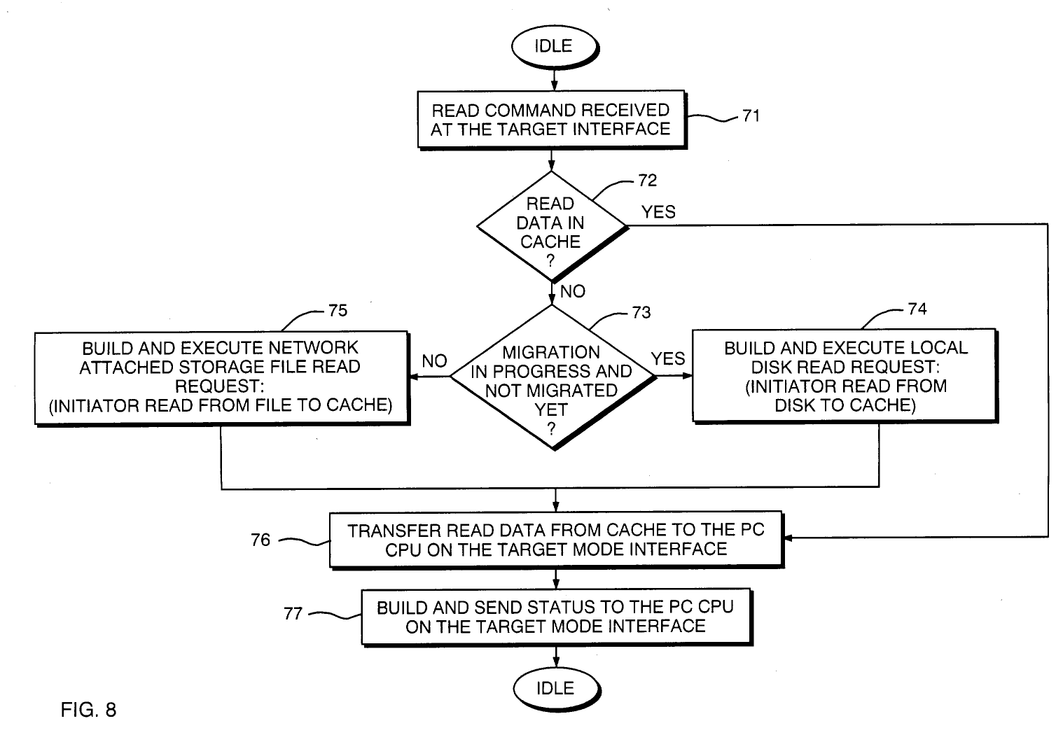

Read processing, as depicted in flowchart form in FIG. 8, proceeds as follows:

The read command is received at the target interface and is processed by apparatus embedded code (71).

A cache lookup for the extent of the read request (starting logical block plus block count) is performed (72).

If the read extent is found in cache (read hit), then the data is transferred from cache memory over the target interface to the PC host CPU (76) and read processing is completed by building and sending driver interface status over the target interface (77).

If the read extent is not in cache (read miss), then NVRAM is checked to see if a migration is in progress and if so whether the extent has been migrated from local disk to the filer (73).

If read miss data has been migrated, then a network attached storage file request is built and executed over the initiator interface (75) to get the read data into apparatus cache memory. Once the read data transfer from the network attached storage device is completed the read data is transferred over the target interface (76) to the PC host CPU and read processing is complete completed by building and sending driver interface status over the target interface.

If the read miss data has not been migrated, then a local disk read request is built and executed over the initiator interface (74) to get the read data into apparatus cache memory. Once the read data transfer from the local disk device (76) is completed the read data is transferred over the target interface to the PC host CPU and read processing is complete.

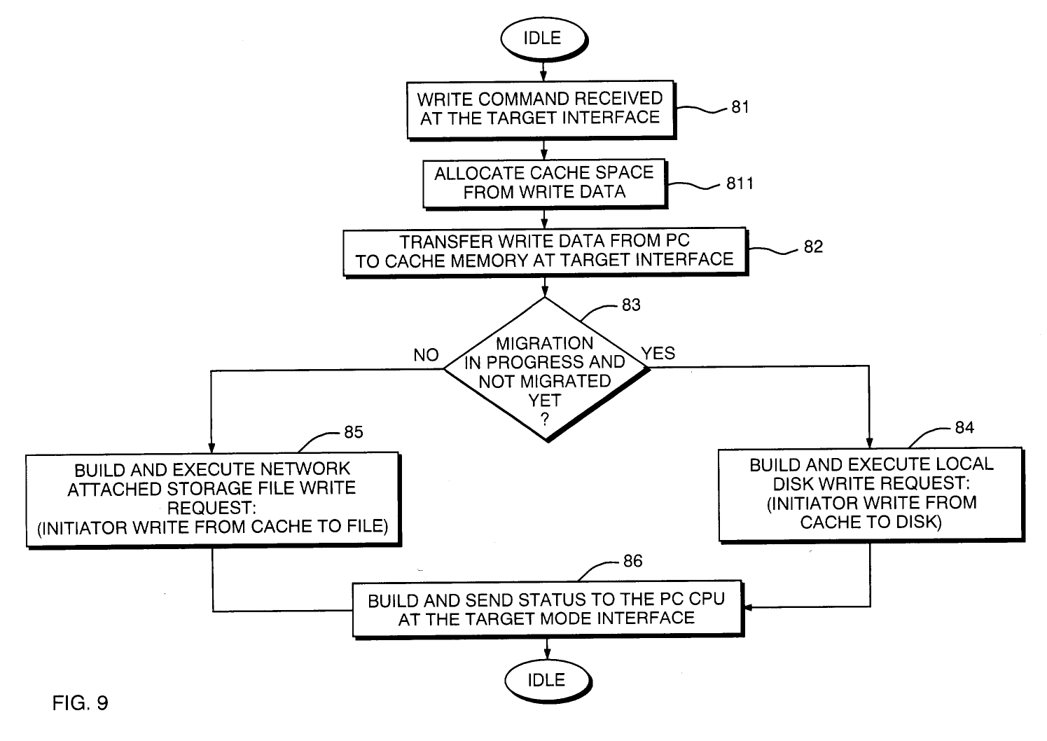

Write processing, as depicted in flowchart form in FIG. 9, proceeds as follows:

The write command is received at the target interface and is processed by apparatus embedded code (81).

Cache memory is reserved for the write data (81) and a data transfer request from the PC CPU over the target interface is started and executed (82).

If the write data in cache has been migrated (83), then a network attached storage file request is built and executed over the initiator interface (85) to send the write data from apparatus from cache memory via the initiator interface to the network attached storage file.

If the write data in cache has not been migrated (83), then a local PC drive request is built and executed over the initiator interface (84) to send the write data from apparatus cache memory via the initiator interface to the drive.

Once the write data has been successfully written to media (local disk or remote network attached storage), successful drive interface status is composed and returned by the apparatus embedded code over the target interface to the PC CPU (86).

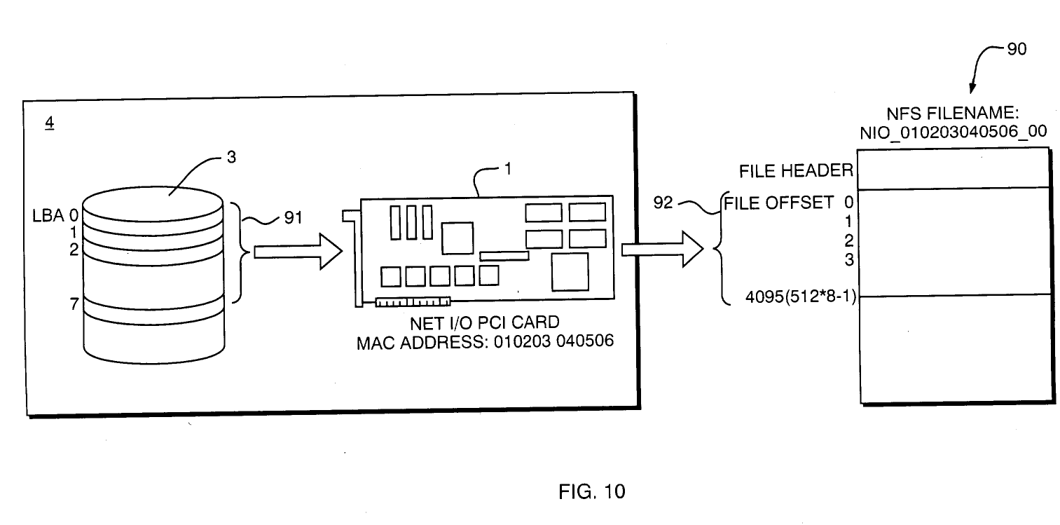

FIG. 10 illustrates how the addresses of a hard drive I/O request is translated into an NFS file offset by the embedded software running on the Net I/O apparatus (1). During initialization, the Net I/O apparatus (1) obtains the stored MAC address of the Ethernet port on the Net I/O PCI card and the TCP/IP address of the NFS file server where a copy of the hard drive is being maintained. The Net I/O firmware next uses the standard “fopen” system call to opens the NFS file(s) associated with a copy of the hard drive being protected. In this example, the first file representing the contents of the hard drive (90) has file name: NIO_{—}010203040506_{—}00 where 010203040506 is the MAC address and 00 indicates that it is the first file associated with this particular hard drive.

Now consider an 8 block read to logical block address 0 on the hard drive (3) within a PC or server (4) with the block size being a typical 512 Bytes per block. The range of the I/O request is therefore 4096 bytes as indicated in the diagram with label 91. The Net I/O embedded code maps the 4096 bytes of hard drive blocks data into a stream of bytes at file offset 0 as indicated in the diagram with label 92 and performs a standard fread system call to read the requested data.

As can now be appreciated, the invention provides numerous advantages over the prior art. Network Attached Storage subsystems (a.k.a. appliances) are easy to install and deploy yielding centrally managed data management and protection. By migrating locally attached storage to a NAS appliance as described in the subject invention, the vast majority of local hard drive data that is currently not backed up can be transparently protected and centrally managed. Utilizing the subject invention, the contents of a user's local hard drive have been migrated to a network attached storage subsystem device. There is no exposure to data loss due to a local hard drive failure. With the subject invention, a traditional restore after a hard drive failure is never needed, yielding no interruption of service, and no restore traffic on the network.

The need for a data migration after a PC upgrade is also eliminated utilizing the subject invention. The data already resides on a network attached storage subsystem, so it does not need to move. For example, consider a PC user who has installed the subject invention and all data requests are being routed to a network attached file system. The user acquires a new PC, removes the subject invention from the old PC, installs it in the new PC, and then plugs it into the network. The data is instantly available obviating the need for a data migration.

The subject invention positions a large amount of high speed memory in the Net I/O apparatus that is pretending that is a disk while routing requests to network storage. To improve system performance, the number of network storage requests are decreased by using caching techniques that buffer write requests, keep frequently referenced blocks of data in memory and pre-fetch blocks that will soon be read into memory.

In contrast to Network Attached Storage and thin client computing, the subject invention supports diskless boot by transparently responding to local disk requests as if it were a local hard drive, and then re-routing those requests to a network attached file system.

Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included with the scope of the invention as defined by the appended claims.

What is claimed is:

1. A data processing system comprising:
a host Central Processing Unit CPU, located within a housing, the host CPU running a host operating system, and the host CPU having a system bus for interconnecting other data processing system components to the host CPU;
an I/O interface for connecting the host system bus to an I/O device bus so that data may be transferred to and from the host CPU;
a network interface, for accessing data to be read and written by the host CPU via a network attached storage unit; and
a storage manager, the storage manager being located within the same housing as the host processor, the storage manager connected to receive data from both the processor and the network interface, the storage manager providing a programming environment that is independent of the host operating system, and the storage manager intercepting requests for access to a local disk drive that occur on the I/O interface, and redirecting such requests to the network interface in a manner that is independent of the host system bus configuration.

2. A system as in claim 1 wherein the storage manager is located in an in-band location on the I/O device bus between the I/O interface and the disk storage unit.

3. A system as in claim 1 wherein the storage manager additionally comprises a user interface to provide a user access to configuration data.

4. A system as in claim 1 wherein storage manager commands are sent to the apparatus inter-mingled within an I/O stream over the device I/O bus.

5. A system as in claim 1 wherein storage manager commands are sent to the apparatus through the Ethernet interface by means of a telnet or Hyper Text Transfer Protocol (HTTP) a TCP/IP interface.

6. A system as in claim 1 wherein the disk storage interface is configured as a standard disk storage interface selected from the group consisting of Integrated Device Electronics (IDE), Enhanced IDE (EIDE), Advanced Technology Attachment (ATA), serial Advanced Technology Attachment (ATA), Small Computer System Interface (SCSI), Internet SCSI (iSCSI), Advanced Technology Attachment (ATA), and Fiber Channel.

7. A system as in claim 1 wherein a front end bus interface of the storage manager connected to the host I/O interface may have a different standard interface specification than that of a back end bus interface of the storage manager connected to the hard disk drive(s).

8. A system as in claim 7 wherein the front end and back end I/O bus interfaces are Small Computer System Interface (SCSI) compatible.

9. A system as in claim 6 wherein a front end and a back end I/O bus interface are Integrated Device Electronics (IDE) compatible.

10. A system as in claim 7 wherein the front bus I/O interface is Small Computer System Interface(SCSI) compatible and the back end I/O interface is Integrated Device Electronics (IDE) compatible.

11. A system as in claim 1 wherein the storage manager uses a software architecture implemented over a multithreaded real time operating system to isolate a front end interface, network interface, and management functions as separate tasks.

12. A system as in claim 1 wherein the storage manager is provided within a standard disk drive enclosure format.

13. A system as in claim 1 wherein the storage manager is provided in a Peripheral Component Interconnect (PCI) interface board format.

14. A system as in claim 1 wherein the storage manager is provided in an integrated circuit format.

15. A system as in claim 1 wherein the storage manager intercepts drive requests based on logical block addresses and translates them to byte offsets within a file residing on the network attached storage.

16. A system as in claim 1 wherein the storage manager maps disk access requests for specific local drive blocks to Network File System file names.

17. A system as in claim 14 wherein the Network File System file names contain an address of the network interface.

18. A system as in claim 15 wherein the address of the network interface is a Media Access Control (MAC) layer address.

19. A system as in claim 1 wherein the storage manager intercepts drive requests arriving on the front end I/O bus interface which are based on logical block addresses and forwards them over the network interface as block requests directed towards an Internet Small Computer System Interface (iSCSI) storage subsystem.
